(19) United States
(12) Patent Application Publication
(10) Pub. No.: US 2016/0247119 A1
(43) Pub. Date: Aug. 25, 2016

(54) RATING SYSTEM CHARACTERIZING ATHLETES BASED ON SKILLSET

(71) Applicant: Richard H. Goates, Heber City, UT (US)

(72) Inventor: Richard H. Goates, Heber City, UT (US)

(21) Appl. No.: 14/628,581

(22) Filed: Feb. 23, 2015

(51) Int. Cl. G06Q 10/10; G06Q 50/00

(52) U.S. Cl. CPC G06Q 10/1053; G06Q 50/01

(57) ABSTRACT

Methods and systems are described for an athlete rating system. A method for rating an athlete includes data collected from a variety of sources. The collected data includes information on attributes and skills associated with the athlete. Users of the rating system are able to view and rate an athlete by sport. Athletes can use the rating system to upload media content for viewing by users. The rating system enables athletes to scout potential competitors, teammates before viewing them play. Additionally, the rating system enables users to rate an athlete after playing with or viewing the athlete in a sporting event.

### BACKGROUND

Athletes everywhere are constantly put in the position of playing with or against unfamiliar athletes. It is difficult to know who to team up with or how to defend or compete against unfamiliar athletes. There is no social media platform that captures peer-submitted scouting reports and evaluations of the skills that make an athlete good, great, or elite. As a result, teams are forced to rely on the opinion of the one person who has actually played with this new player. Often, this leaves a team with a “bad fit” which provides for a less than positive experience for the new player as well as the other members of the team.

Competitive athletes also have an inherent desire to express respect and admiration to those athletes who have earned it. Competitive athletes desire to acknowledge specific skills that another athlete has clearly spent significant time developing or attributes that otherwise make that athlete special. There is no social media platform to do so in such a way that the expression of admiration or respect is created, documented as part of a permanent record, and preserved for an athletes own enjoyment and for the athlete's posterity.

Fans have a desire to participate at some level in professional sports. Our society has seen a huge increase in the popularity of “fantasy” sports. Fans do not have a way of interacting with players during the live or televised game or contest in such a way that the athletes are getting real-time feedback for the things they are doing well.

Amateur athletes in many sports aspiring to play at the next level often find it difficult to be discovered and scouted unless they have the financial wherewithal to attend national tournaments and camps. This is especially true in underprivileged and rural communities and in the less mainstream sports with smaller recruiting budgets. No social media, interactive platform exists where a player can build a peer-bolstered on-line profile to increase an athlete's on-line reputation and allow him/her to be scouted from any computer or mobile computing device with Internet access.

### SUMMARY

A hardware and/or software rating system is disclosed for calculating one or more ratings for an athlete. Data associated with an athlete is gathered from many sources such as peers, fans and other data sources. According to at least one embodiment, a method for rating an athlete based upon observed skills or attributes, the skills or attributes are selected by a user and attributed to the specific athlete. In one example, a user may select skills or attributes from a table and see the overall rating for a certain athlete.

A hardware and/or software rating system is disclosed as the basis for a social media platform for athletes. According to at least one embodiment, a user of the invention may set up an athletic profile by entering data points about the user's athletic abilities, the profile being further enhanced and augmented by peer, fans or other data sources.

### BRIEF DESCRIPTION OF THE DRAWINGS

A further understanding of the nature and advantages of the embodiments may be realized by reference to the following drawings. In the appended figures, similar components or features may have the same reference label.

FIG. 1 depicts a flow diagram of a process enabling a user to rate and select an athlete's attributes;

FIG. 2 depicts an environment where an athletic rating system may operate;

FIG. 3 is a screenshot of a representative interface depicting a presentation of an athlete and the skills attributed to the athlete based upon athletic ratings by interested third parties

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

A hardware and/or software rating system is disclosed for calculating one or more ratings for an athlete. Data associated with an athlete is gathered from many sources such as peers, fans and other data sources. The collected data includes any information that can be used to determine the athlete's skills and attributes for different sports. One or more ratings may be calculated based upon values assigned to the athlete by interested third parties or the public generally. For example, after a basketball game, a user may use the rating system to rate an opponents skills that were observed during the game. Additionally, persons present at the game may log in to the rating system to rate an athlete base upon observable skills and attributes. A user may log into the system to rate an athlete on a myriad of observable skills. For example, a user may rate an athlete on offensive abilities, defensive abilities, intangibles or miscellaneous categories varied by the sport. The attributes or skills attributable to an athlete are characterized by “props”, and are tallied by the number of ratings received by an athlete. As used herein, “props” means a positive rating for an observible attribute or skill. For example, an athlete may receive many props for defensive skills, the ratings reflecting the athletes prowess as a defensive specialist.

An athlete using the rating system may set up a profile detailing specifics about the athlete's profile. For example, an athlete may list the athlete's age, weight, height and other measurable attributes. Additionally, an athlete may upload video highlights allowing a user to view the athletic abilities of the athlete. Users may use the rating system to effectively scout an unknown opponent athlete by viewing the props assigned to the opponent athlete. Additionally, coaches may use the rating system to effectively scout athletes for recruiting purposes.

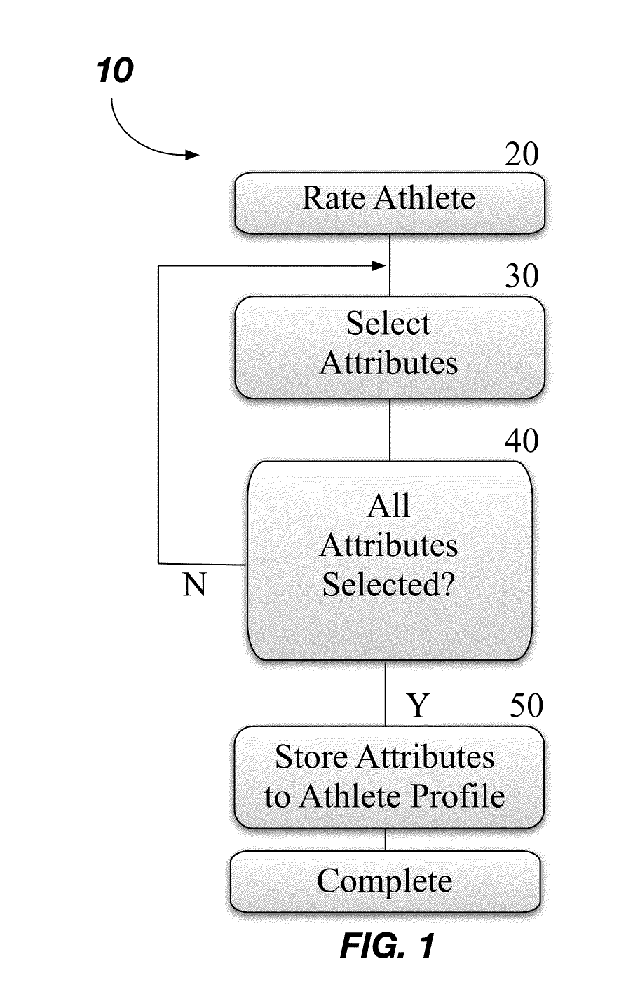

FIG. 1 depicts a flow diagram of a process 10 enabling a user to rate and select an athlete's attributes. The process is performed by a user to create a new rating for the rating system. In block 20, the user selects an athlete to be associated with the new rating. In block 30, the user selects an attribute or attributes to be associated with the athlete as a rating. The rating system allows a user to select multiple attributes assignable to an athlete. The rating system autopopulates suggested attributes, but is robust in allowing a user to enter an attribute if it is not on the autopopulated list. In decision block 40, if a user has not completed the rating process, the process loops back to block 30 so that the user can select additional attributes to attribute to the athlete, else the process continues to block 50. In block 50, the process stores the attributes to the athlete profile selected by the user.

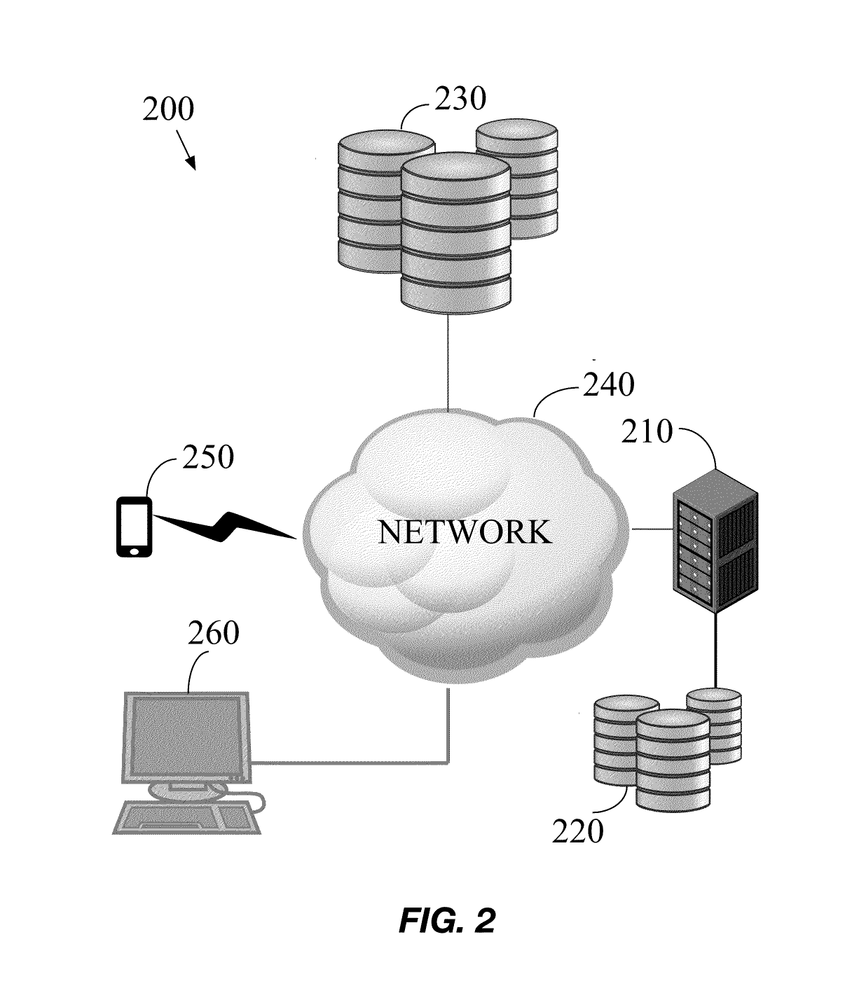

FIG. 2 depicts an environment where an athletic rating system 200 may operate. The rating system 200 comprises one or more servers 210 connected to one or more integral or external data storage areas 220 (such data storage areas contained in memory or other storage medium such as optical hard drives or solid state hard drives etc.). The server contains one or more processors to access computer programs, procedures, and data that are stored in the data storage areas, and execute the instructions contained within the stored programs and procedures. Athletes rated by the system are rated based upon multiple data sources 230. Multiple data sources 230 may be peers, fans, or data sources such as public records for athletic performance found in newspapers or on the Internet. The data sources may be accessed through public or private networks 240, such as the Internet. Based upon the attributes or props associated with an athlete, a rating is generated for athletes. Users may access the rating system on personal mobile devices 250 or computers 260. Users may upload data 230 or props to the system 200 using personal mobile devices 250 or computers 260. Based upon the ratings of users and other data 230, ratings are generated for users to allow for a graphical rating to be displayed for the public. Athletes may augment their profiles on the rating system by adding data 230 such as videos or images and other physical attributes. The system 200 is a source for rating athletes as well as a social media platform allowing athletes to interact with fans, coaches, other athletes or any other user of the system 200. The rating is derived primarily from input from users and other data 230 sources.

An athletes rating or ratings are based on data received from various data sources 230. The data may be pushed by the data sources to the rating system, or the data may be pulled from the data sources (e.g. via calls to an application program interface, or API, or scraping of a website). As new data sources 230 become available or as new ratings come in from users, an athletes profile will be updated to reflect the new information.

The data obtained by the athlete rating system may be any data that reflects the abilities, skills or attributes of an athlete. Depending on the sport, the data generally falls under one of four categories: offensive skills, defensive skills, intangibles or miscellaneous. The offensive skills may reflect the athletes ability to score from long range or short range or to assist teammates as an example. The four categories are generally divided into major skillsets or minor.

An athletes profile in the rating system may display many data points that help to profile the athlete's abilities. An athlete may augment the athlete's profile by posting awards won such as tournament placement or other accolades such as honors from athletic bodies. Additionally, an athlete may augment a profile by identifying teammates and listing the historical record, or wins and losses, of the athletes efforts in the past. An athlete may post what future leagues it is wanting to play in or if it is looking for teammates. Those skilled in the art will appreciate that the rating system is a platform for users not only to rate athletes, but connect with athletes for many different sporting purposes.

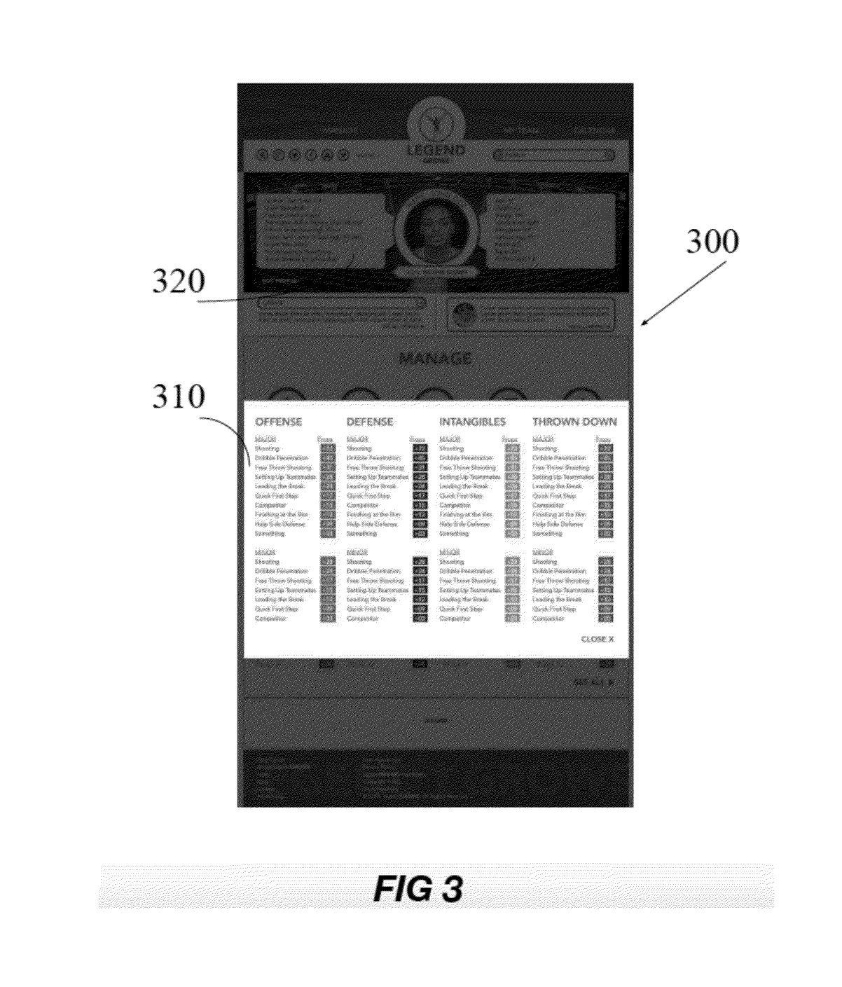

Once ratings have been compiled for an athlete, the rating system may display the ratings to users in a variety of ways. FIG. 3 is a screen shot of a representative interface 300 that depicts one way an athlete rating system may be presented to users. Users viewing the interface 300 would be able to see props 310 attributed to the athlete and categorized by skill area. The props 310 show a representative tally of how many users have selected an attribute or skill as attributable to an athlete. The athletic profile 320 displays the athletes name and other attributes. The props 310 vary by sport. In the interface 300, the props 310 correspond to an athlete's basketball rating. Different props 310 would populate if a different sport, other than basketball, was selected for the athlete. For example, the props 310 for baseball may display an athletes hitting ability. Additionally, the athletic profile 320 would display different information if baseball was selected such as the athlete's batting average or ERA if the athlete was a pitcher. Those skilled in the art will appreciate that the rating system is very robust to be able to adjust to different sports for a given athlete.

While the foregoing disclosure sets forth various embodiments using specific block diagrams, flowcharts, and screenshot, each block diagram component, flowchart step, operation, described and/or illustrated herein may be implemented, individually and/or collectively, using a wide range of hardware, software, or firmware (or any combination thereof) configurations.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A method for determining one or more ratings of an athlete in an athlete rating system, the method comprising:
identifying a plurality of attributes indicative of an athlete's abilities;
collecting data associated with at least some of the identified plurality of attributes for an athlete from a plurality of sources; and
determining one or more ratings for the athlete by:
calculating each rating based on the attributes for each athlete, wherein each rating is comprised of a different combination of attributes.

2. The method of claim 1, wherein the plurality of attributes is sourced from public databases maintained by public entities.

3. The method of claim 1, wherein the rating is weighted based upon time by:
determining a higher value for attributes that are more recently attributed to the athlete than attributes that are historical.

4. A computing system for disseminating an indication of athlete rating information, the system comprising:
a data-collecting component configured to collect athlete attribute information from a plurality of sources;
a rating configuration receiving component configured to receive configuration information identifying one or more attributes associated with each of the plurality of athlete ratings;
a receiving component configured to transmit an indication of the ranking for the athlete in response to a received request.

5. The computing system of claim 4, wherein the rating is indicated in a graphically showing the requester of the rating an overview of all attributes for a given sport.

6. The computing system of claim 4, wherein the rating for an athlete is delineated by sport, wherein attributes are associated by sport to the athlete.

7. The computing system of claim 4, wherein the rating for an athlete is accessible by a user via a mobile device, the user having the ability to view and rate an athlete through the mobile device.

8. A method for rating a rating system for athletes, comprising:
receiving information from users of the rating system and other sources relative to the athlete's skills and attributes;
displaying in the rating system the skills and attributes attributed to the athlete;
the rating system displaying a list of skills and attributes that a user can select as being attributable to an athlete;
the rating system calculates a rating based upon the input from users and a plurality of other sources for attributes attributable to the athlete;
the rating system delineating the attributes by sport.

9. The method of claim 8, wherein an athlete can supplement the rating by adding videos and other media to the athlete profile.

10. The method of claim 8, wherein an athlete can supplement the rating by adding profile information on the report.

11. The method of claim 8, wherein an athlete can add other athletes or users to his profile and elect to receive updates from updates made by other athletes or users.
